(19) United States
(12) Patent Application Publication
(10) Pub. No.: US 2010/0016037 A1
(43) Pub. Date: Jan. 21, 2010

(54) CELL PHONE EARPIECE RETAINER

(76) Inventors: Jerry Maytum, Lancaster, CA (US); Rebecca Maytum, Lancaster, CA (US)

Correspondence Address: BELASCO, JACOBS & TOWNSLEY LLP;HOWARD HUGHES CENTER, 6701 CENTER DRIVE WEST, 14th Floor, LOS ANGELES, CA, 90045, US

(21) Appl. No.: 12/176,271

(22) Filed: Jul. 18, 2008

(51) Int. Cl. H04M 1/00

(52) U.S. Cl. 455/575.2

(57) ABSTRACT

A cell phone earpiece retainer includes a first attaching loop formed of resilient material, sized and shaped to fit frictionally about an ear mounting portion of a cell phone earpiece. An elongate strap portion has a first and second ends and is attached at the first end to the first attaching loop. A fastening means is attached to the second end of the strap portion. When the first attaching loop is fastened to an ear mounting of the cell phone earpiece and the fastening means is removably attached to any of a user's clothing, hair or eyeglass frame, the earpiece will be protected from loss. The fastening means may include a clip having first and second jaws, each having a gripping portion and an opening portion. The gripping portions are biased toward one another by a spring means and biased away from one another by pressure on the opening portions.

### FIELD OF INVENTION

This invention relates to the field of retaining devices, and more specifically to devices designed to prevent inadvertent loss of wireless remote earpieces for use with cellular telephones.

### BACKGROUND OF THE INVENTION

The use of wireless remote earpieces for use with cell phones has become increasingly common. These miniature headset devices were once restricted to indoor use by receptionists and other office workers. With the advent of Bluetooth® wireless systems incorporated into most cellular telephones, the use of compatible wireless earphones has become for everyday use. Such earpieces are now commonly seen outdoors and in use in automobiles. New legislation in some locations will require a “hands free” system for talking on cellular phones in automobiles. These earpieces satisfy this new requirement. Unfortunately, the earpieces are fairly expensive and are attached to the user's ear using frictional means. As a result, it is fairly easy to knock off an earpiece inadvertently in the course of moving about. What is needed is a convenient to use means of safeguarding the earpiece against loss. This patent application addresses this need.

U.S. Patent Application No. 2006/0067524, issued to Smith et al., discloses an ergonomic earpiece that has an acoustic tubing. The lower end of the acoustic tubing is secured to the user's clothing by means of a strap with a small loop at one end and a clip to engage the clothing at the other end

U.S. Pat. No. D494,568, issued to Pan is directed to to the ornamental design for a Bluetooth headset as shown in FIGS. 1-10. The headset is shown with lanyard that engages the earpiece of the headset. The far end of the lanyard is not shown but we could assume it is either for looping around the neck of the wearer or can be clipped to the clothing or the like.

Internet Reference—Amazon.com: Nokia BH-700 Bluetooth Headset a Nokia BH-700 Bluetooth headset as detailed on Amazon.com. The headset is shown with a lanyard connected to a plastic clip that apparently can engage the earpiece of the headset.

Internet Reference—Bluetrek LEVI'S Bluetooth Hands-free headset w/ Lanyard disclose a Bluetrek Levi's Bluetooth hands-free headset with lanyard. The lanyard is shown as a chain connected to what appears to be a plastic sheet with a keyhole adapting it to engage the earpiece of the Bluetrek headset.

Internet reference: UMX Strap Supplies, Lanyards-4-less, and Namifier is directed to three businesses that supply lanyards and straps in a great variety of configurations or allow you to customize or build your own.

Internet reference: cgi.ebay.com/PERSONALIZED-BEADED . . . a personalized beaded baby pacifier clip. The clip as shown has a loop at one end and a clip at the other.

U.S. Pat. No. 7,110,535, issued to Bodley et al. and also U.S. Pat. Nos. 7,130,419; 7,146,004; 7,391,862 and U.S. Pre-Grant Publication 2004/0052363 also by Bodley et al. are directed to a headset communications unit that as shown on FIGS. 22 and 23 of U.S. Pat. No. 7,110,535 and provide for attaching a lanyard with a neck loop to the headset communication unit.

It is an objective of the present invention to provide a means for reliably preventing loss of earpieces for use with cellular telephones. It is a further objective to provide such a means that is inexpensive to produce, durable and easy to use. It is a still further objective of the invention be easy to remove and comfortable to wear. It is yet a further objective to provide a retaining device that can be attached to clothing, eyeglasses or hair. Finally, it is an objective of the present invention to provide a retaining means that can be used as a fashion accessory.

While some of the objectives of the present invention are disclosed in the prior art, none of the inventions found include all of the requirements identified.

### SUMMARY OF THE INVENTION

The present invention addresses all of the deficiencies of prior art cell phone earpiece retainer inventions and satisfies all of the objectives described above.

(1) A cell phone earpiece retainer includes a first attaching loop. The first loop is formed of resilient material and sized and shaped to fit frictionally about an ear mounting portion of a cell phone earpiece. An elongate strap portion is provided. The strap portion has a first end and a second end and is attached at the first end to the first attaching loop. A fastening means is provided. The fastening means is attached to the second end of the strap portion. When the first attaching loop is fastened to an ear mounting portion of the cell phone earpiece and the fastening means is removably attached to any of a user's clothing, hair or eyeglass frame, the earpiece will be protected from loss.

(2) In a variant of the invention, the fastening means further includes a clip. The clip has a first jaw and a second jaw. Each of the first and second jaws has a gripping portion and an opening portion. The first jaw is pivotally attached to the second jaw. The gripping portions are biased toward one another by a spring means and biased away from one another by pressure on the opening portions.

(3) In another variant, the clip is formed of either translucent or transparent material.

(4) In still another variant, the fastening means includes a second attaching loop. The second loop is formed of resilient material and sized and shaped to fit frictionally about an ear mounting portion of either of a pair of eyeglasses and a pair of sunglasses.

(5) In yet another variant, the fastening means further comprises a hair clip.

(6) In a further variant, decorative beads and jewels are located upon the elongate strap portion.

(7) In still a further variant, the elongate strap portion is removably attached to the first attaching loop.

(8) In yet a further variant, the elongate strap portion is removably attached to the second attaching loop.

(9) In a final variant, the elongate strap portion is formed of material selected from the group includes metal, leather, plastic and elastic materials.

An appreciation of the other aims and objectives of the present invention and an understanding of it may be achieved by referring to the accompanying drawings and the detailed description of a preferred embodiment.

### DESCRIPTION OF THE DRAWINGS

FIG. 1 is a side elevational view of the preferred embodiment of the invention including a first attaching loop, strap portion and retaining clip;

FIG. 2 is a perspective view of a second embodiment of the invention illustrating a second attaching loop and beaded decoration of the strap portion; and

FIG. 3 is a perspective view of the FIG. 1 embodiment illustrating attachment of the clip to either hair or clothing of the user and means for removably attaching the strap portion to the first attaching loop.

### DETAILED DESCRIPTION OF THE PREFERRED EMBODIMENT

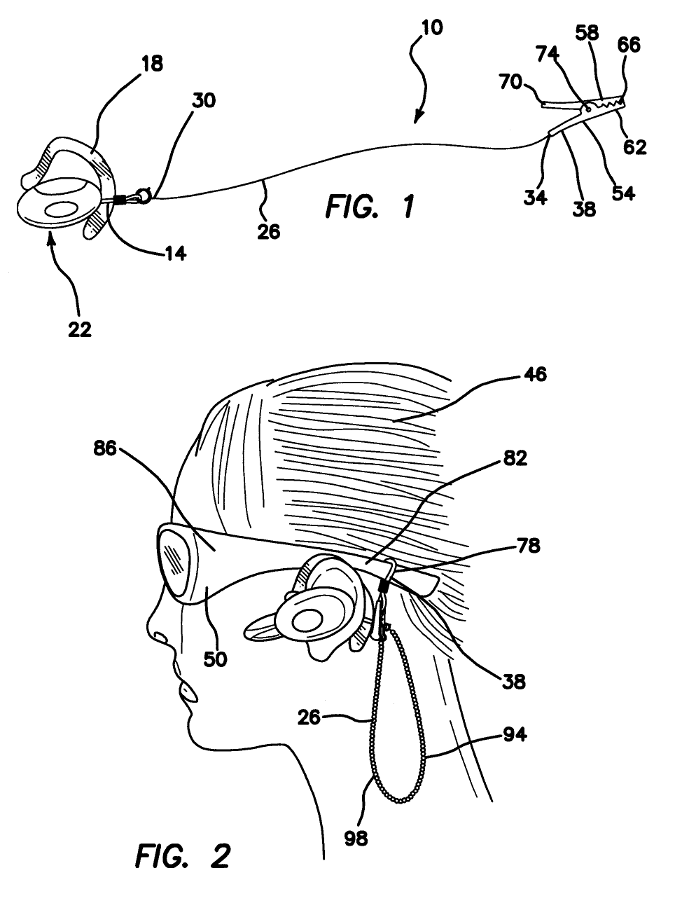

(1) FIGS. 1-3 illustrate a cell phone earpiece retainer 10 that includes a first attaching loop 14. The first loop 14 is formed of resilient material and sized and shaped to fit frictionally about an ear mounting portion 18 of a cell phone earpiece 22. An elongate strap portion 26 is provided. The strap portion 26 has a first end 30 and a second end 34 and is attached at the first end 30 to the first attaching loop 14. A fastening means 38 is provided. The fastening means 38 is attached to the second end 34 of the strap portion 26. When the first attaching loop 14 is fastened to an ear mounting portion 18 of the cell phone earpiece 22 and the fastening means 38 is removably attached to any of a user's clothing 42, hair 46 or eyeglass frame 50, the earpiece 22 will be protected from loss.

(2) In a variant of the invention, the fastening means 38 further includes a clip 54. The clip 54 has a first jaw 58 and a second jaw 62. Each of the first 58 and second 62 jaws has a gripping portion 66 and an opening portion 70. The first jaw 58 is pivotally attached to the second jaw 62. The gripping portions 66 are biased toward one another by a spring means 74 and biased away from one another by pressure on the opening portions 70.

(3) In another variant, the clip 54 is formed of either translucent or transparent material 78.

(4) In still another variant, as illustrated in FIG. 2, the fastening means 38 includes a second attaching loop 78. The second loop 78 is formed of resilient material and sized and shaped to fit frictionally about an ear mounting portion 82 of either of a pair of eyeglasses 86 and a pair of sunglasses (not shown).

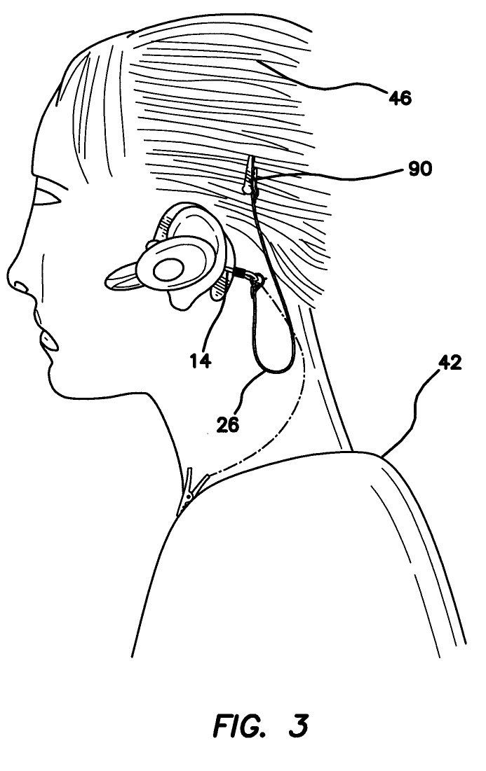

(5) In yet another variant, as illustrated in FIG. 3, the fastening means 38 further comprises a hair clip 90.

(6) In a further variant, as illustrated in FIG. 2, decorative beads 94 and jewels 98 are located upon the elongate strap portion 26.

(7) In still a further variant, as illustrated in FIGS. 1 and 3, the elongate strap portion 26 is removably attached to the first attaching loop 14.

(8) In yet a further variant, as illustrated in FIG. 2, the elongate strap portion 26 is removably attached to the second attaching loop 78.

(9) In a final variant, the elongate strap portion 26 is formed of material selected from the group includes metal, leather, plastic and elastic materials.

The cell phone earpiece retainer 10 has been described with reference to particular embodiments. Other modifications and enhancements can be made without departing from the spirit and scope of the claims that follow.

1. A cell phone earpiece retainer comprising:
a first attaching loop, said first loop being formed of resilient material and sized and shaped to fit frictionally about an ear mounting portion of a cell phone earpiece;
an elongate strap portion, said strap portion having a first end and a second end and being attached at said first end to said first attaching loop;
a fastening means, said fastening means attached to said second end of said strap portion; and
whereby, when said first attaching loop is fastened to an ear mounting portion of said cell phone earpiece and said fastening means is removably attached to any of a user's clothing, hair or eyeglass frame, said earpiece will be protected from loss.

2. The cell phone earpiece retainer, as described in claim 1, wherein said fastening means further comprises:
a clip, said clip having a first jaw and a second jaw;
each of said first and second jaws having a gripping portion and an opening portion;
said first jaw being pivotally attached to said second jaw, said opening portions being biased toward one another by a spring means and biased away from one another by pressure on said opening portions.

3. The cell phone earpiece retainer, as described in claim 2, wherein said clip is formed of either of translucent and transparent material.

4. The cell phone earpiece retainer, as described in claim 1, wherein said fastening means further comprises a second attaching loop, said second loop being formed of resilient material and sized and shaped to fit frictionally about an ear mounting portion of either of a pair of eyeglasses and a pair of sunglasses.

5. The cell phone earpiece retainer, as described in claim 1, wherein said fastening means further comprises a hair clip.

6. The cell phone earpiece retainer, as described in claim 1, wherein either of decorative beads and jewels are disposed upon said elongate strap portion.

7. The cell phone earpiece retainer, as described in claim 1, wherein said elongate strap portion is removably attached to said first attaching loop.

8. The cell phone earpiece retainer, as described in claim 4, wherein said elongate strap portion is removably attached to said second attaching loop.

9. The cell phone earpiece retainer, as described in claim 1, wherein said elongate strap portion is formed of material selected from the group comprising:
metal, leather, plastic and elastic materials.
